(19) United States
(12) Patent Application Publication
(10) Pub. No.: US 2018/0285532 A1
(43) Pub. Date: Oct. 4, 2018

(54) IRX

(71) Applicant: Ali Mahmoud. Farhat, Dearborn, MI (US)

(72) Inventor: Ali Mahmoud. Farhat, Dearborn, MI (US)

(21) Appl. No.: 15/472,344

(22) Filed: Mar. 29, 2017

(51) Int. Cl. G06F 19/00

(52) U.S. Cl. CPC G06F 19/3456; G06F 19/328

(57) ABSTRACT

An app to simplify the way patients can order their medication via uploading the script just like a check deposit mechanism on their smartphones. The app includes these steps: the patient signs up as an individual or family by upload a photo id and providing insurance info, doctor info and credit card info against which to charge any co pay and a fee in case the patient decides to cancel the order after being accepted; the patient enters present and past medications; and the patient will get an alert once a refill is due, thereby enabling pharmacies to compete to give better prices and better service, including home.

An app to simplify the way patients can order their medication via uploading the script just like a check deposit mechanism on their smartphones.

First, the patient will sign up as an individual or family, upload photo ID, insurance info, doctor info, and credit card on file to charge the co-pay and a fee in case the patient decides to actually just cancel the order for no reason after being accepted. (Registration is a one time sign-up).

Patient will have present and past medications being consumed and it will be very easy to track, especially for a family or older patients.

Patient will get an alert once refill is due and insurance companies or government assistance programs can stop a lot of fraud and save.

Patients will be getting their refills now. Pharmacies will compete to give better prices and better service and will deliver to patients, especially older people. It will be up to the client to pick a delivery or pick-up option.

I claim:

1. An app to simplify the way patients can order their medication via uploading the script just like a check deposit mechanism on their smartphones, the app including these steps:
the patient signs up as an individual or family by upload a photo id and providing insurance info, doctor info and credit card info against which to charge any co pay and a fee in case the patient decides to cancel the order after being accepted;
the patient enters present and past medications;
the patient will get an alert once a refill is due, thereby enabling pharmacies to compete to give better prices and better service, including home delivery if desired.
